(19) United States
(12) Patent Application Publication
(10) Pub. No.: US 2011/0085728 A1
(43) Pub. Date: Apr. 14, 2011

(54) DETECTING NEAR DUPLICATE IMAGES

(76) Inventors: Yuli Gao, Palo Alto, CA (US); Feng Tang, Mountain View, CA (US)

(21) Appl. No.: 12/576,236

(22) Filed: Oct. 8, 2009

(51) Int. Cl. G06K 9/46

(52) U.S. Cl. 382/165; 382/195; 382/224; 382/170

(57) ABSTRACT

Near duplicate images are detected based on local structure feature matching of local features that are extracted from the images. The matching process also may involve detecting near duplicate images based on metadata features and global image features. A computation-sensitive cascaded classifier may be used together with an on-demand feature extraction to detect near duplicate images with improved efficiency and reduced computational cost.

### BACKGROUND

Since the advent of digital cameras and video camcorders, multimedia content creation has become a much easier task for both professional and amateur photographers. As the sizes of personal media collections continue to grow, the problem of media organization, management and utilization has become a much more pressing issue. Recently, many intelligent multimedia management tools have been built by the research community to attack this problem, such as content-based image/video retrieval and semantic tagging. One core problem underneath these content-analysis and management tools is the issue of image matching; that is, given two images, how to quantify their “similarity” such that it truly reflects users' perceptual similarity in the problem domain. This image matching problem has been heavily researched for decades. Recently there has been increasing interest in using these basic matching techniques to detect near duplicates among image/video collections, mainly due to its wide range of potential applications, such as personal image clustering and video threading.

What are needed are improved apparatus and methods of detecting matching images with high efficiency and effectiveness.

### SUMMARY

In one aspect, the invention features a method in accordance with which a first set of local features is extracted from a first image and a second set of the local features is extracted from a second image. One or more candidate matches of the local features in the first set and the second set are determined. For each of the candidate matches, the following operations are performed. A first group of a specified number of nearest neighbors of the local feature of the candidate match in the first image is selected. A second group of the specified number of nearest neighbors of the local feature of the candidate match in the second image is chosen. Matches between the neighboring local features in the first group and corresponding neighboring local features in the second group are ascertained. The candidate match is designated as either a true match or a non-match based on the ascertained matches between nearest neighbor local features. The first and second images are classified as either near duplicate images or non-near duplicate images based on the true matches.

In another aspect, the invention features a method in accordance with which features in a current feature set are extracted from a first image and a second image. The current feature set is in a sequence of successive feature sets that consist of respective sets of constituent features and are arranged in order of increasing computational cost associated with extraction of their respective constituent features. The first image and the second image are classified as either near duplicate image pair or candidate non-near-duplicate image pair based on the extracted features. In response to each classification of the first image and the second image as candidate non-near duplicate images based on the extracted values of the current feature set, the extraction and classification are repeated with the next successive one of the feature sets following the current feature set in the sequence as the current feature set.

In another aspect, the invention features a method in accordance with which a sequence of successive feature sets is determined. The features sets consist of respective sets of constituent features and are arranged in order of increasing computational cost associated with extraction of values of their respective constituent features. A cascade of successive classification stages is built. In this process, each of the classification stages is trained on a respective one of the feature sets such that the classification stage is operable to classify images as either near duplicate images or candidate non-near duplicate images based on the features of the respective feature set that are extracted from the images. The classification stages are arranged successively in the order of the successive feature sets in the sequence.

The invention also features apparatus operable to implement the methods described above and computer-readable media storing computer-readable instructions causing a computer to implement the methods described above.

### DESCRIPTION OF DRAWINGS

FIG. 1 is a block diagram of an embodiment of a near duplicate image detection system.

FIG. 2 is a flow diagram of an embodiment of a method of detecting near duplicate images.

FIG. 3 is a diagrammatic view of candidate local features and a specified number of their respective nearest neighbor local features in a pair of images in accordance with an embodiment of the invention.

FIG. 4 is a diagrammatic view of a weighting mask in accordance with an embodiment of the invention.

FIG. 5 is a block diagram of an embodiment of a cascaded classifier.

FIG. 6 is a flow diagram of an embodiment of a method of building an embodiment of the cascaded classifier of FIG. 5.

FIG. 7 is a flow diagram of an embodiment of a method of detecting near duplicate images.

FIG. 8 is a block diagram of an embodiment of a computer system that incorporates an embodiment of the near duplicate detection system of FIG. 1.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale.

I. DEFINITION OF TERMS

The term “near duplicate” refers to an image that contains substantially the same content as another image. Two images containing substantially the same content are considered near duplicates even if they have different layouts or formats. The process of detecting near duplicates of a given image also will detect exact duplicates of the given image.

A “computer” is any machine, device, or apparatus that processes data according to computer-readable instructions that are stored on a computer-readable medium either temporarily or permanently. A “computer operating system” is a software component of a computer system that manages and coordinates the performance of tasks and the sharing of computing and hardware resources. A “software application” (also referred to as software, an application, computer software, a computer application, a program, and a computer program) is a set of instructions that a computer can interpret and execute to perform one or more specific tasks. A “data file” is a block of information that durably stores data for use by a software application.

II. DETECTING NEAR DUPLICATE IMAGES

The embodiments that are described herein provide systems and methods that are capable of detecting near duplicate images with high efficiency and effectiveness.

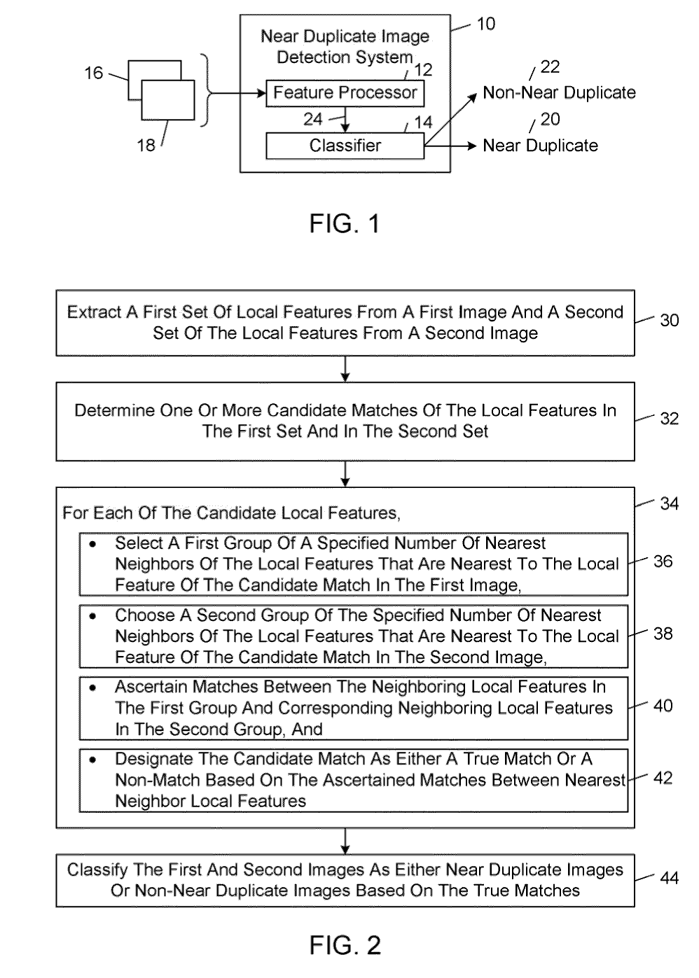

FIG. 1 shows an embodiment of a near duplicate image detection system 10 that includes a feature processor 12 and a classifier 14. In operation, the classifier 14 classifies a pair of images 16, 18 as either near duplicate images 20 or non-near duplicate images 22 based on features 24 that are extracted from the images 16, 18 by the feature processor 12.

FIG. 2 shows an embodiment of a method by which the image match detection system 10 determines whether or not the images 16 and 18 are near duplicate images. In accordance with the method of FIG. 2, the feature processor 12 extracts a first set of local features from a first image and a second set of the local features from a second image (FIG. 2, block 30). The feature processor 12 determines one or more candidate matches of the local features in the first set and in the second set (FIG. 2, block 32).

For each of the candidate matches, the feature processor 12 performs the following operations (FIG. 2, block 34). The feature processor 12 selects a first group of a specified number of nearest neighbor ones of the local features that are nearest to the local feature of the candidate match in the first image (FIG. 2, block 36). The feature processor 12 chooses a second group of the specified number of nearest neighbor ones of the local features that are nearest to the local feature of the candidate match in the second image (FIG. 2, block 38). The feature processor 12 ascertains matches between ones of the neighbor local features in the first group and corresponding ones of the nearest neighbor local features in the second group (FIG. 2, block 40). The feature processor 12 designates the candidate match as either a true match or a non-match based on the ascertained matches between nearest neighbor local features (FIG. 2, block 42).

The classifier 14 classifies the first and second images as either near duplicate images or non-near duplicate images based on the true matches (FIG. 2, block 44).

In general, any of a wide variety of different local descriptors may be used to extract the local feature values (FIG. 2, block 30), including distribution based descriptors, spatial-frequency based descriptors, differential descriptors, and generalized moment invariants. In some embodiments, the local descriptors include a scale invariant feature transform (SIFT) descriptor and one or more textural descriptors (e.g., a local binary pattern (LBP) feature descriptor, and a Gabor feature descriptor).

In some embodiments, the feature processor 12 applies an ordinal spatial intensity distribution (OSID) descriptor to the first and second images 16, 18 to produce respective ones of the local feature values 24. The OSID descriptor is obtained by computing a 2-D histogram in the intensity ordering and spatial sub-division spaces, as described in F. Tang, S. Lim, N. Chang and H. Tao, “A Novel Feature Descriptor Invariant to Complex Brightness Changes,” CVPR 2009 (June 2009). By constructing the descriptor in the ordinal space instead of raw intensity space, the local features are invariant to any monotonically increasing brightness changes, improving performance even in the presence of image blur, viewpoint changes, and JPEG compression. In some embodiments, the feature processor 12 first detects local feature regions in the first and second images 16, 18 using, for example, a Hessian-affine region detector, which outputs a set of affine normalized image patches. An example of a Hessian-affine region detector is described in K. Mikolajczyk et al., “A comparison of affine region detectors,” International Journal of Computer Vision (IJCV) (2005). The feature processor 12 applies the OSID descriptor to the detected local feature regions to extract the OSID feature values from the first and second images 16, 18. This approach makes the resulting local feature values robust to view-point changes.

In some embodiments, the feature processor 12 determines the candidate matches (FIG. 2, block 32) based on bipartite graph matching of the local features in the first set to respective ones of the local features in the second set. In this process, each local feature from the first image is matched against all local features from the second image independently. The result is an initial set of candidate matches from feature sets S and D, where S={f₁^{s},f₂^{s}, . . . , f_{Ns}^{s}} and D={f₁^{d},f₂^{d}, . . . , f_{Nd}^{d}}. The matches initially generated with bipartite matching are denoted as M={{fᵢ^{s},fⱼ^{d}}, 1≦i≦Ns, 1≦j≦Nd}.

The feature processor 12 prunes the initial set of candidate matches based on the degree to which the local structure (represented by the nearest neighbor local features) in the neighborhoods of the local features of the candidate matches in the first and second images 16, 18 match (FIG. 2, block 34). Instead of using a fixed radius to define the local neighborhoods, the feature processor 12 defines the neighborhoods adaptively by selecting a specified number (K) of the nearest neighbor local features closest to the local features of the candidate matches (FIG. 2, blocks 36, 38). This approach makes the detection process robust to scale changes.

The local structure/neighborhood of fᵢ^{s} in feature set S is denoted LSᵢ^{s}={fᵢ₁^{s},fᵢ₂^{s}, . . . , f_{K}^{s}}, which are the nearest K local features in S to the feature fᵢ^{s}. Similarly, the local structure of fⱼ^{d} in feature set D is denoted LSⱼ^{D}={fⱼ₁^{d}, fⱼ₂^{d}, . . . , f_{K}^{d}}. The feature processor 12 prunes the set of candidate matches by comparing the local structures LSᵢ^{S} and LSⱼ^{D}. If there is sufficient match between the local structures of a given candidate local feature in the first and second images 16, 18, then the candidate match is designated as a true match; otherwise the candidate match is designated as a non-match and is pruned from the set (FIG. 2, block 42).

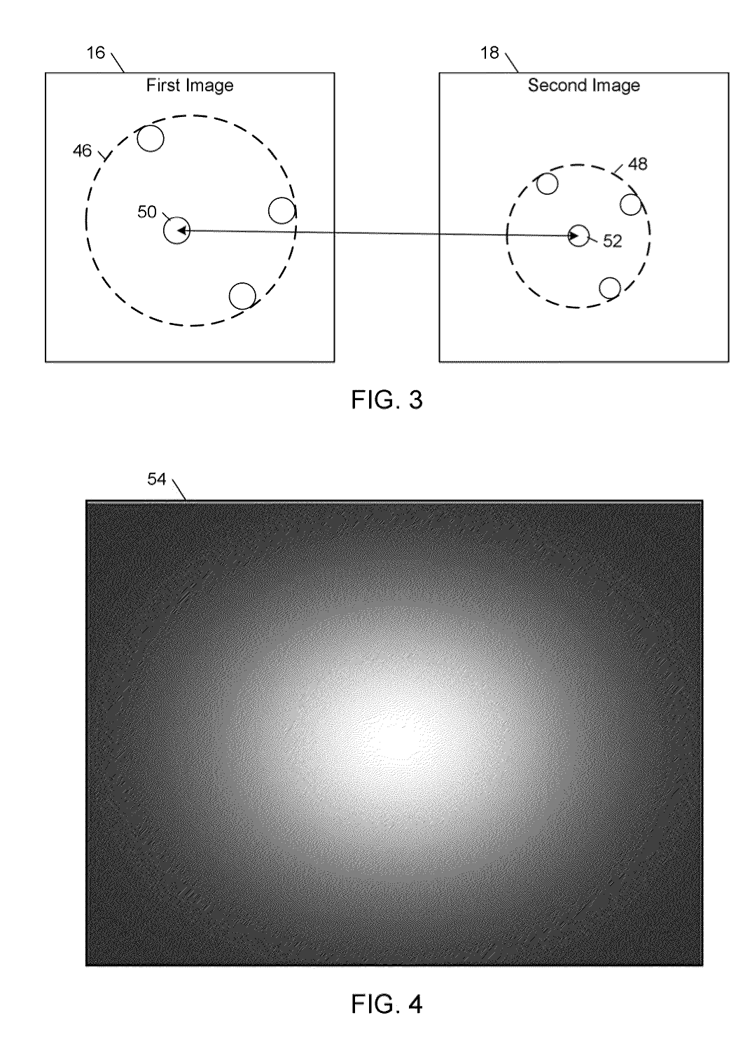

FIG. 3 shows a pair of exemplary adaptively defined neighborhoods 46, 48 of candidate matching local features 50, 52 in the first and second images 16, 18. In this example, the neighborhoods are defined by the three nearest local features (i.e., K=3). Depending on the degree of match between the nearest neighbor features of the local feature 50 and the nearest neighbor features of the matching local feature 52, the candidate match consists of the local features 50, 52 will de declared a true match or a non-match.

In some embodiments, for each of the candidate matches, the feature processor 12 tallies the ascertained matches between nearest neighbor local features to obtain a count of the ascertained matches, and designates the candidate match as either a true match or a non-match based on the application of a threshold to the count of the ascertained matches. In some of these embodiments, the feature processor 12 determines how many feature pairs with one from LSᵢ^{S} and the other from LSⱼ^{D} belong to the initial set of candidate matches M, and this matched set is denoted as LSM_{i,j}={{fₘ^{s},fₙ^{d}}∈M, fₘ^{s}∈LSᵢ^{s}, fₙ^{d}∈LSⱼ^{d}}. The confidence of the match {fᵢ^{s},fᵢ^{d}} is denoted card(LSM_{i,j})/K, where card(*) is the cardinality of the set. If the confidence is below a threshold level, the feature processor 12 regards the candidate match as a mismatch and prunes it from the set. The final set of true matches for an image pair Iₚ and I_{q} is denoted as FM={{ᵢ^{Ip},fⱼ^{Iq}}, 1≦i≦Ns, 1≦j≦Nd}.

After the feature processor 12 identifies the final set of true matches (FIG. 2, block 42), the feature processor 12 uses the true matches to compute a matching score that measures the degree to which the first and second images 16, 18 match one another. In some embodiments, the feature processor 12 determines the matching score by counting the number of true matches; this treats all the matches equally regardless where the features are located in the first in second images 16, 18.

In other embodiments, the feature processor 12 determines a weighted sum of the true matches, where the sum is weighted based on locations of the local features of the true matches in the first and second images. In some of these embodiments, the feature processor 12 takes into account the users attention by giving more weight to those true match features that fall within a specified attention region. In general, the attention region may be defined in a variety of different ways. In some embodiments, the attention region is defined as a central region of an image. A weighting mask is defined with respect to the attention region, where the weights assigned to locations in the attention region are higher than the weights assigned to locations outside the attention region. In some embodiments, the weighting mask is a Gaussian weighting mask (W(x,y)) that gives more weight to true match local features that are close to the image center and less weight to the true match local features near the image boundary. FIG. 4 shows an exemplary embodiment of a Gaussian weighting mask 54, where brighter regions correspond to higher weights and darker regions correspond to lower weights. In these embodiments, the matching score (MS) between image Iₚ and image I_{q} is determined by evaluating:

MS(Iₚ,I_{q})=ΣᵢW(x_{G}_{ᵢ},y_{Gi}) (1)

where Gᵢ=fᵢ^{Ip}, and {fᵢ^{Ip}}∈FM(Iₚ, I_{q}). In some embodiments, makes the matching score symmetric by computing the following symmetric matching score (SMS):

SMS(Iₚ,I_{q})=(MS(Iₚ,I_{q})+MS(I_{q},Iₚ))/2 (2)

In some embodiments, the classifier 14 classifies the first and second images as either matching near duplicate or non-near duplicate images based on the symmetric matching score (FIG. 2, block 44).

In some embodiments, the classifier 14 discriminates near duplicate images from non-near duplicate images classification based on the symmetric matching scores defined in equation (2) and one or more other image features, including image metadata, global image features, and local image features.

In some embodiments, the feature processor 12 extracts values of metadata features (e.g. camera model, shot parameters, image properties, and capture time metadata) from the first and second images 16, 18, and the classifier 14 classifies the first and second images 16, 18 as either near duplicate images or non-near duplicate images based on the extracted metadata feature values. The metadata features typically are extracted from an EXIF header that is associated with each image 16, 18. One exemplary metadata feature that is used by embodiments of the classifier 14 for detecting a match between two images is the difference in the capture time metadata of the two images.

In some embodiments, the feature extractor 12 extracts one or more global features (e.g., adaptive color histogram) from the first and second images 16, 18, and the classifier 14 classifies the first and second images 16, 18 as either matching images or non-matching images based on the extracted adaptive color histograms. In some of these embodiments, an adaptive color histogram is extracted from each of the images 16, 18 and used by the classifier 14 for match detection. In these embodiments, the number of bins in the color histograms and their quantization are determined by adaptively clustering image pixels in LAB color space. One exemplary metadata feature that is used by embodiments of the classifier 14 for detecting a match between two images is the difference or dissimilarity between the adaptive color histograms of the two images. In some embodiments this dissimilarity is measured by the Earth Mover Distance measure, which is described in Y. Rubner et al., “The earth mover distance as a metric for image retrieval,” IJCV, 40(2) (2000).

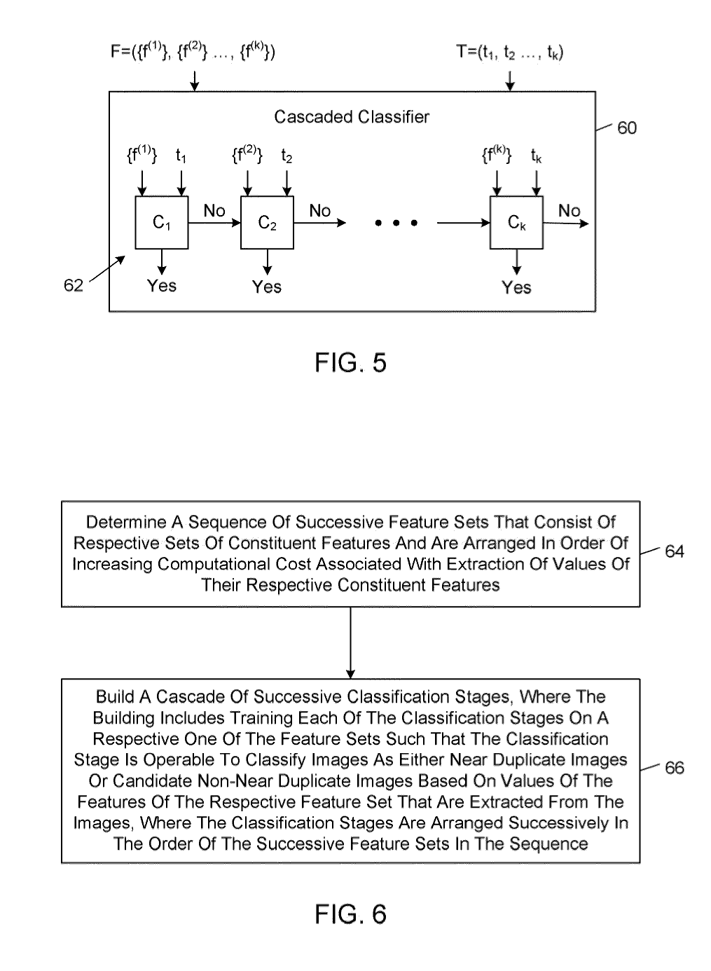

FIG. 5 shows an embodiment 60 of the classifier 14 that includes a cascade 62 of k classification stages (C₁, C₂, Cₖ), where k has an integer value greater than 1. Each classification stage Cᵢ has a respective classification boundary that is controlled by a respective threshold tᵢ, where: i=1, . . . , k. In the illustrated embodiment, each of the classification stages (C₁, C₂, . . . , Cₖ) performs a binary discrimination function that classifies a pair of images into one of two classes (near duplicate or non-near duplicate) based on a discrimination measure that is computed from one or more features (F={f₁, f₂, . . . , fₙ}={f⁽¹⁾, f⁽²⁾, . . . , f^{(m)}}, where each f⁽¹⁾ is a cluster of features as described below) that extracted from the images. The value of the computed discrimination measure relative to the corresponding threshold determines the class into which the image pair will be classified by each classification stage. In particular, if the discrimination measure that is computed for the image pair is above the threshold for a classification stage, the image pair is classified into one of the two classes whereas, if the computed discrimination measure is below the threshold, the image pair is classified into the other class. In this way, each stage classifier accepts/rejects image pair samples if it has high confidence in doing so, and passes on the not-so-confident image pair samples to successive stage classifiers.

In some embodiments, the classification stages 62 are ordered in accordance with the computational cost associated with the extraction of the features on which the classifications are trained, where the front-end classifiers are trained on features that are relatively less computationally expensive to extract and the back-end classifiers are trained on features that are relatively more computationally expensive to extract. This classifier structure, together with an on-demand feature extraction process in which only those features that are required by the current classification stage are extracted, yields significant efficiency gains and computational cost savings. The end result is that the easy image pair samples tend to get classified with cheap features; this not only reduces computational costs but also avoids the need to compute expensive features.

FIG. 6 shows an embodiment of a method of building the cascaded classifier 60. In accordance with this method, a sequence of successive feature sets is determined (FIG. 6, block 64). The features sets consist of respective sets of constituent features and are arranged in order of increasing computational cost associated with extraction of values of their respective constituent features. A cascade of successive classification stages is built (FIG. 6, block 66). In this process, each of the classification stages is trained on a respective one of the feature sets such that the classification stage is operable to classify images as either matching images or candidate non-matching images based on values of the features of the respective feature set that are extracted from the images. The classification stages are arranged successively in the order of the successive feature sets in the sequence.

Some embodiments of the classifier building process of FIG. 6 are implemented as follows. Given a set of training image pair samples X={X+, X−}, where X+ are positive samples and X− are negative samples, represented in a feature space F={f₁, f₂, . . . , fₙ},
1. Cluster features based on their computational cost into m categories, i.e., F={f⁽¹⁾, f⁽²⁾, . . . , f^{(m)}}, where f⁽ⁱ⁾={fᵢ₁, fᵢ₂, . . . fᵢⱼ} and ∀fᵢⱼ∈f⁽ⁱ⁾ has similar computational cost. The feature clusters are ranked so that the cost of computing f^{(u)} is cheaper than f^{(v)}, if u<v;
2. For i=1:k
   a. Bootstrap X to {Xₜ⁺,Xₜ⁻}∪{Xᵥ⁺,Xᵥ⁻} and train a stage boosting classifier Cᵢ using feature set f⁽¹⁾∪ . . . ∪f⁽ⁱ⁾ on training set Xₜ⁺∪Xₜ⁻.
   b. Set threshold tᵢ for Cᵢ such that the recall rate of Cᵢ(tᵢ) on the validation set Xᵥ⁺∪Xᵥ⁻ is over a preset level R close to 1 (this is to enforce the final classifier has a high recall).
   c. Remove from X the samples that are classified by Cᵢ(tᵢ) as negative.
3. The final classifier C is the cascade of all stage classifiers Cᵢ(tᵢ), i=1, . . . , k.

The classification stages 62 are trained on progressively more expensive, yet more powerful feature spaces. At test time, if a test sample is rejected by cheap stage classifier Cₗ(tᵢ), none of the rest of the more stage classifiers Cⱼ(Tⱼ), j>i, will be triggered, therefore avoiding the extraction of more expensive features.

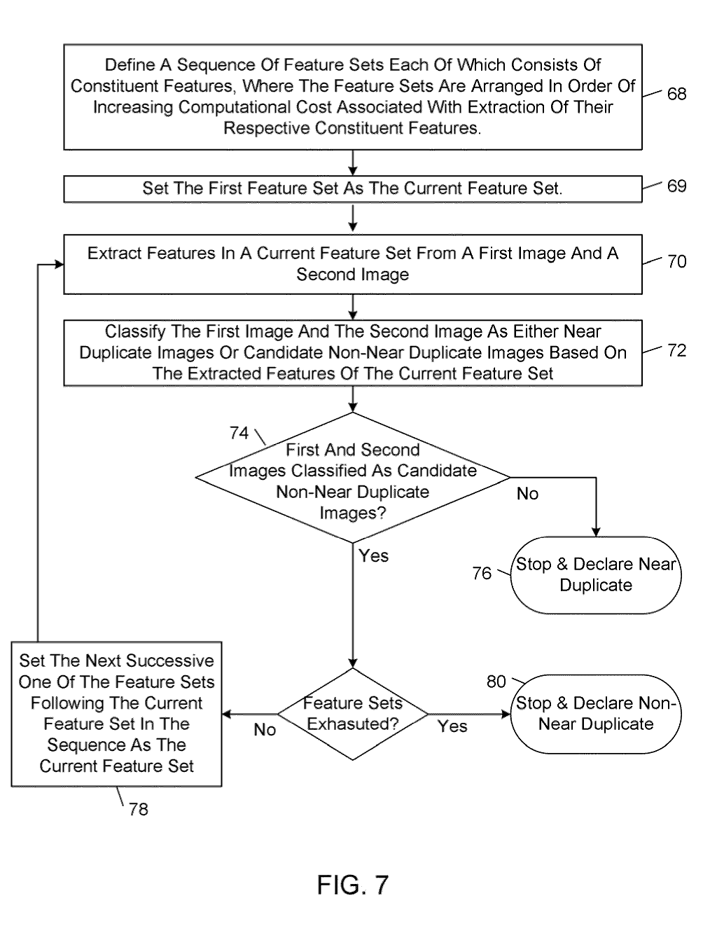

FIG. 7 shows an embodiment by which the cascaded classifier 60 classifies a pair of images. In accordance with this method, a sequence of feature sets is defined, where each of the feature sets consists of constituent features (FIG. 7, block 68). The feature sets are arranged in order of increasing computational cost associated with extraction of their respective constituent features. The first feature set in the sequence is set as the current feature set (FIG. 7, block 69). The feature processor 12 extracts features in a current feature set from a first image and a second image (FIG. 7, block 70). The cascaded classifier 60 classifies first image and the second image as either near duplicate images or candidate non-near duplicate images based on the extracted values (FIG. 7, block 72). In response to each classification of the first image and the second image as candidate non-near duplicate images based on the extracted features of the current feature set (FIG. 7, block 74), the near duplicate image detection system repeats the extraction of the current feature set (FIG. 7, block 70), the classification of the first and second images (FIG. 7, block 72), and the repetition of the extraction and classification (FIG. 7, blocks 74, 70, 72) with the next successive one of the feature sets following the current feature set in the sequence as the current feature set (FIG. 7, block 78). In response to a classification of the first image and the second image as near duplicate images based on the extracted features of the current feature set (FIG. 7, block 74), the near duplicate image detection system terminates the repetition of feature extraction and classification processes and designates the image pair as near duplicates (FIG. 7, block 76). The process repeats until the feature sets in the sequence have been exhausted, at which point the near duplicate image detection system stops and designates the image pair as non-near duplicates (FIG. 7, block 80).

III. EXEMPLARY OPERATING ENVIRONMENT

Each of the images 16, 18 (see FIG. 1) may correspond to any type of image, including an original image (e.g., a video keyframe, a still image, or a scanned image) that was captured by an image sensor (e.g., a digital video camera, a digital still image camera, or an optical scanner) or a processed (e.g., sub-sampled, filtered, reformatted, enhanced or otherwise modified) version of such an original image.

Embodiments of the image match detection system 10 may be implemented by one or more discrete modules (or data processing components) that are not limited to any particular hardware, firmware, or software configuration. In the illustrated embodiments, these modules may be implemented in any computing or data processing environment, including in digital electronic circuitry (e.g., an application-specific integrated circuit, such as a digital signal processor (DSP)) or in computer hardware, firmware, device driver, or software. In some embodiments, the functionalities of the modules are combined into a single data processing component. In some embodiments, the respective functionalities of each of one or more of the modules are performed by a respective set of multiple data processing components.

The modules of the image match detection system 10 may be co-located on a single apparatus or they may be distributed across multiple apparatus; if distributed across multiple apparatus, these modules and the display 24 may communicate with each other over local wired or wireless connections, or they may communicate over global network connections (e.g., communications over the Internet).

In some implementations, process instructions (e.g., machine-readable code, such as computer software) for implementing the methods that are executed by the embodiments of the image match detection system 10, as well as the data they generate, are stored in one or more machine-readable media. Storage devices suitable for tangibly embodying these instructions and data include all forms of non-volatile computer-readable memory, including, for example, semiconductor memory devices, such as EPROM, EEPROM, and flash memory devices, magnetic disks such as internal hard disks and removable hard disks, magneto-optical disks, DVD-ROM/RAM, and CD-ROM/RAM.

In general, embodiments of the image match detection system 10 may be implemented in any one of a wide variety of electronic devices, including desktop computers, workstation computers, and server computers.

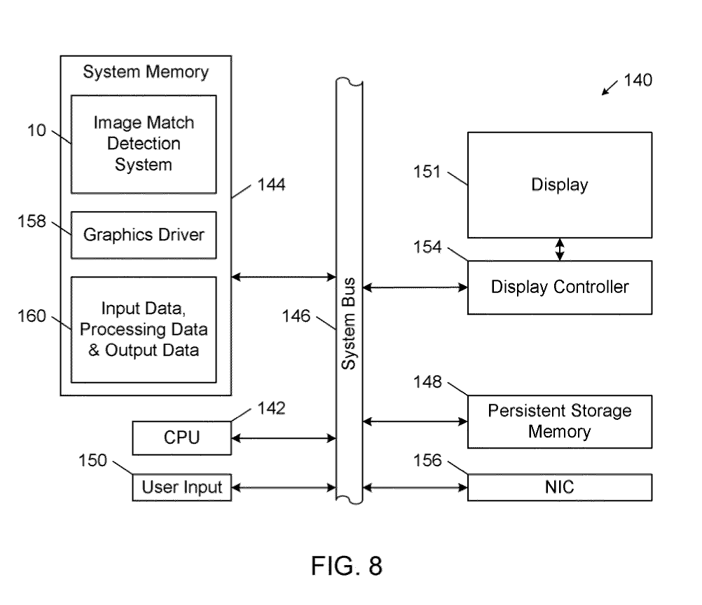

FIG. 8 shows an embodiment of a computer system 140 that can implement any of the embodiments of the image match detection system 10 that are described herein. The computer system 140 includes a processing unit 142 (CPU), a system memory 144, and a system bus 146 that couples processing unit 142 to the various components of the computer system 140. The processing unit 142 typically includes one or more processors, each of which may be in the form of any one of various commercially available processors. The system memory 144 typically includes a read only memory (ROM) that stores a basic input/output system (BIOS) that contains start-up routines for the computer system 140 and a random access memory (RAM). The system bus 146 may be a memory bus, a peripheral bus or a local bus, and may be compatible with any of a variety of bus protocols, including PCI, VESA, Microchannel, ISA, and EISA. The computer system 140 also includes a persistent storage memory 148 (e.g., a hard drive, a floppy drive, a CD ROM drive, magnetic tape drives, flash memory devices, and digital video disks) that is connected to the system bus 146 and contains one or more computer-readable media disks that provide non-volatile or persistent storage for data, data structures and computer-executable instructions.

A user may interact (e.g., enter commands or data) with the computer 140 using one or more input devices 150 (e.g., a keyboard, a computer mouse, a microphone, joystick, and touch pad). Information may be presented through a user interface that is displayed to a user on the display 151 (implemented by, e.g., a display monitor), which is controlled by a display controller 154 (implemented by, e.g., a video graphics card). The computer system 140 also typically includes peripheral output devices, such as speakers and a printer. One or more remote computers may be connected to the computer system 140 through a network interface card (NIC) 156.

As shown in FIG. 8, the system memory 144 also stores the image match detection system 10, a graphics driver 158, and processing information 160 that includes input data, processing data, and output data. In some embodiments, the image match detection system 10 interfaces with the graphics driver 158 (e.g., via a DirectX® component of a Microsoft Windows® operating system) to present a user interface on the display 151 for managing and controlling the operation of the image match detection system 10.

IV. CONCLUSION

The embodiments that are described herein provide systems and methods that are capable of detecting matching images with high efficiency and effectiveness.

Other embodiments are within the scope of the claims.

1. A method, comprising:
extracting a first set of local features from a first image and a second set of the local features from a second image;
determining one or more candidate matches of the local features in the first set and in the second set;
for each of the candidate matches,
selecting a first group of a specified number of nearest neighbor ones of the local features that are nearest to the local feature of the candidate match in the first image,
choosing a second group of the specified number of nearest neighbor ones of the local features that are nearest to the local feature of the candidate match in the second image,
ascertaining matches between ones of the neighbor local features in the first group and corresponding ones of the nearest neighbor local features in the second group, and
designating the candidate match as either a true match or a non-match based on the ascertained matches between nearest neighbor local features; and
classifying the first and second images as either near duplicate images or non-near duplicate images based on the true matches.

2. The method of claim 1, wherein the extracting comprises applying an ordinal spatial intensity distribution descriptor to the first and second images to produce respective ones of the local features.

3. The method of claim 1, wherein the determining comprises determining the candidate matches based on bipartite graph matching of the local features in the first set to respective ones of the local features in the second set.

4. The method of claim 1, wherein the designating comprises tallying the ascertained matches between nearest neighbor local features to obtain a count of the ascertained matches, and designating the candidate match as either a true match or a non-match based on the application of a threshold to the count of the ascertained matches.

5. The method of claim 1, further comprising calculating a local feature matching score between the first and second images based on the true match.

6. The method of claim 5, wherein the calculating comprises determining a weighted sum of the true matches, the sum being weighted based on locations of the local features of the true matches in the first and second images.

7. The method of claim 1, further comprising extracting metadata features from the first and second images, and the classifying comprises classifying the first and second images as either near duplicate images or non-near duplicate images based on the extracted metadata features.

8. The method of claim 7, wherein the extracting of the metadata features comprises extracting capture time metadata from the first and second images, and the classifying comprises classifying the first and second images as either near duplicate images or non-near duplicate images based on the extracted capture time metadata.

9. The method of claim 1, further comprising extracting a respective adaptive color histogram from each of the first and second images, and the classifying comprises classifying the first and second images as either near duplicate images or non-near duplicate images based on the extracted adaptive color histograms.

10. Apparatus, comprising:
a computer-readable medium storing computer-readable instructions; and
a data processor coupled to the computer-readable medium, operable to execute the instructions, and based at least in part on the execution of the instructions operable to perform operations comprising
extracting a first set of local features from a first image and a second set of the local features from a second image;
determining one or more candidate matches of the local features in the first set and in the second set;
for each of the candidate matches,
selecting a first group of a specified number of nearest neighbor ones of the local features that are nearest to the local feature of the candidate match in the first image,
choosing a second group of the specified number of nearest neighbor ones of the local features that are nearest to the local feature of the candidate match in the second image,
ascertaining matches between ones of the neighbor local features in the first group and corresponding ones of the nearest neighbor local features in the second group, and
designating the candidate match as either a true match or a non-match based on the ascertained matches between nearest neighbor local features; and
classifying the first and second images as either near duplicate images or non-near duplicate images based on the true matches.

11. At least one computer-readable medium having computer-readable program code embodied therein, the computer-readable program code adapted to be executed by a computer to implement a method comprising:
extracting a first set of local features from a first image and a second set of the local features from a second image;
determining one or more candidate matches of the local features in the first set and in the second set;
for each of the candidate matches,
selecting a first group of a specified number of nearest neighbor ones of the local features that are nearest to the local feature of the candidate match in the first image,
choosing a second group of the specified number of nearest neighbor ones of the local features that are nearest to the local feature of the candidate match in the second image,
ascertaining matches between ones of the neighbor local features in the first group and corresponding ones of the nearest neighbor local features in the second group, and
designating the candidate match as either a true match or a non-match based on the ascertained matches between nearest neighbor local features; and
classifying the first and second images as either near duplicate images or non-near duplicate images based on the true matches.

12. The at least one computer-readable medium of claim 11, further comprising calculating a local feature matching score between the first and second images based on the true matches, wherein the calculating comprises determining a weighted sum of the matching local features, the sum being weighted based on locations of the local features of the true matches in the first and second images.

13. The at least one computer-readable medium of claim 11, wherein the extracting comprises extracting metadata features from the first and second images, and the classifying comprises classifying the first and second images as either near duplicate images or non-near duplicate images based on the extracted metadata features.

14. The at least one computer-readable medium of claim 11, wherein the extracting comprises extracting a respective adaptive color histogram from each of the first and second images, and the classifying comprises classifying the first and second images as either near duplicate images or non-near duplicate images based on the extracted adaptive color histograms.

15. A method, comprising:
extracting features in a current feature set from a first image and a second image, wherein the current feature set is in a sequence of successive feature sets that consist of respective sets of constituent features and are arranged in order of increasing computational cost associated with extraction of their respective constituent features;
classifying the first image and the second image as either near duplicate images or candidate non-near duplicate images based on the extracted features in the current feature set;
in response to each classification of the first image and the second image as candidate non-near duplicate images based on the extracted features of the current feature set, repeating the extracting, the classifying, and the repeating with the next successive one of the feature sets following the current feature set in the sequence as the current feature set.

16. The method of claim 10, wherein in each of different repetitions of the extracting, the extracting comprises a different respective one of: applying an ordinal spatial intensity distribution descriptor to the first and second images to produce respective ones of the features; extracting metadata features from the first and second images; and extracting a respective adaptive color histogram from each of the first and second images.

17. The method of claim 10, wherein in response to a classification of the first image and the second image as near duplicate images based on the extracted features of the current feature set, terminating the repeating.

18. Apparatus, comprising:
a computer-readable medium storing computer-readable instructions; and
a data processor coupled to the computer-readable medium, operable to execute the instructions, and based at least in part on the execution of the instructions operable to perform operations comprising
extracting features in a current feature set from a first image and a second image, wherein the current feature set is in a sequence of successive feature sets that consist of respective sets of constituent features and are arranged in order of increasing computational cost associated with extraction of their respective constituent features;
classifying the first image and the second image as either near duplicate images or candidate non-near duplicate images based on the extracted features in the current feature set;
in response to each classification of the first image and the second image as candidate non-near duplicate images based on the extracted features of the current feature set, repeating the extracting, the classifying, and the repeating with the next successive one of the feature sets following the current feature set in the sequence as the current feature set.

19. At least one computer-readable medium having computer-readable program code embodied therein, the computer-readable program code adapted to be executed by a computer to implement a method comprising:
extracting features in a current feature set from a first image and a second image, wherein the current feature set is in a sequence of successive feature sets that consist of respective sets of constituent features and are arranged in order of increasing computational cost associated with extraction of their respective constituent features;
classifying the first image and the second image as either near duplicate images or candidate non-near duplicate images based on the extracted features in the current feature set;
in response to each classification of the first image and the second image as candidate non-near duplicate images based on the extracted features of the current feature set, repeating the extracting, the classifying, and the repeating with the next successive one of the feature sets following the current feature set in the sequence as the current feature set.

20. A method, comprising:
determining a sequence of successive feature sets that consist of respective sets of constituent features and are arranged in order of increasing computational cost associated with extraction of their respective constituent features;
building a cascade of successive classification stages, wherein the building comprises training each of the classification stages on a respective one of the feature sets such that the classification stage is operable to classify images as either near duplicate images or candidate non-near duplicate images based on the features of the respective feature set that are extracted from the images, wherein the classification stages are arranged successively in the order of the successive feature sets in the sequence.
